(19) United States
(12) Patent Application Publication
(10) Pub. No.: US 2026/0044405 A1
(43) Pub. Date: Feb. 12, 2026

(54) RISK-BASED OPERATIONS MANAGEMENT GUIDANCE FROM HISTORICAL SERVICE AND DEVICE OBSERVABILITY

(71) Applicant: Cisco Technology, Inc., San Jose, CA (US)

(72) Inventors: Steve Michael Holl, Sarasota, FL (US); Jason A. Kuhne, Hopkinton, MA (US); Gonzalo Salgueiro, Raleigh, NC (US); Jason Michael Coleman, Hendersonville, NC (US)

(21) Appl. No.: 18/797,840

(22) Filed: Aug. 8, 2024

(51) Int. Cl. G06F 11/07; G06F 11/00; G06F 11/36

(52) U.S. Cl. CPC G06F 11/0793; G06F 11/008; G06F 11/3688

(57) ABSTRACT

In one embodiment, a method includes associating, to classifiers assigned to a plurality of groups of devices of a network to identify device commonality that is distinct for each group of the plurality of groups, historical confidence scores with which a task remediates an alert event. When a first device of the devices reports the alert event, the method includes identifying each classifier to which the first device belongs and each historical confidence score for each classifier. At least one risk score associated with the task is generated using at least the each historical confidence score, and the at least one risk score is provided to a system. The method also includes obtaining an indication of whether the task is to be executed on the first device from the system.

### TECHNICAL FIELD

The present disclosure relates generally to remediation of device faults in a network.

### BACKGROUND

As information technology (IT) infrastructure becomes more complex, properly implementing changes to network infrastructure is increasingly important. Implementing changes to a network infrastructure without considering consequences of the changes may introduce issues into the network infrastructure. For example, an action such as a change made to a network infrastructure in an effort to remediate a detected fault may give rise to adverse chain-effects when feedback on how the action may affect critical services running over the top of an IT infrastructure is not accounted for. Many conventional approaches to making changes to a network infrastructure, as for example to address faults in the network, do not manage the risk of making those changes.

### BRIEF DESCRIPTION OF THE DRAWINGS

FIG. 1 is a process flow diagram which illustrates a method of implementing a change in a network by considering a historical confidence score in accordance with an embodiment.

FIG. 2 is a process flow diagram which illustrates a method of obtaining one or more risk scores for a task, e.g., step 113 of FIG. 1, in accordance with an embodiment.

FIG. 3 is a process flow diagram which illustrates a method of a change implementer causing one or more decisions to be made regarding a task, e.g., step 125 of FIG. 1, in accordance with an embodiment.

FIG. 4 is a diagrammatic representation of an overall system which enables a historical confidence score to be considered when determining whether to cause a task to be performed in accordance with an embodiment.

FIG. 5 is a diagrammatic representation of a datastore, e.g., datastore 406 of FIG. 4, in accordance with an embodiment.

FIG. 6 is a process flow diagram which provides an example method of identifying and processing a service-adjacent or service-related alert event, e.g., step 105 of FIG. 1, in accordance with an embodiment.

FIG. 7 is a diagrammatic representation of a computing device that may perform functions associated with operations associated with implementing a change in accordance with an embodiment.

FIG. 8 is a diagrammatic representation of service supported by an equipment infrastructure and a service test employed to test service health in accordance with an example embodiment.

### DETAILED DESCRIPTION

### Overview

In an embodiment, a method includes associating, to classifiers assigned to a plurality of groups of devices of a network to identify device commonality that is distinct for each group of the plurality of groups, historical confidence scores with which a task remediates an alert event. When an alert event is reported, the method includes identifying each classifier to which the first device belongs and each historical confidence score for each classifier. At least one risk score associated with the task is generated, and the at least one risk score is provided to an information technology service management (ITSM) system or a decision making system. The method also includes obtaining an indication of whether the task is to be executed on the first device from the ITSM system and to improve confidence in in a successful remediation of the device alert.

### Example Embodiments

The ability to remediate faults, or issues, detected in a network infrastructure enables the network infrastructure to continue to operate. However, in some situations, when a fault is remediated, the act of remediating the fault by performing a task may cause other issues in a network infrastructure. In other words, there are risks associated with performing or executing a task in an effort to address an issue in a network infrastructure, as performing the task may not actually solve the issue and/or may cause other issues to arise.

To provide an ability to effectively manage risks associated with network operations, confidence scores or measurements may be calculated or otherwise determined for specific tasks that address actionable faults or alert events. The historical confidence scores for a task may be provided to a decision maker or decision making system such that an assessment may be made as to whether a fault or alert event is considered to be actionable, as well as to gauges the service risk of a remediating task, and/or provide additional optimization for the task/change such as the optimal time of day to perform the task. When a fault or alert event is determined to be actionable, a decision may be made as to whether a particular task is to be run or executed, e.g., whether a particular action is to be implemented, to address the fault or alert event and, in the event that it is determined that the particular task is to be run or executed, enabling another decision to be made as to when to execute the particular task. For example, historical confidence scores or probabilities may indicate that a particular task that causes an infrastructure change is to be performed during a maintenance window or at a particular time of day to substantially minimize a risk of causing other issues to arise or minimize risk to the overall business services.

Service tests are used to understand a historical impact of change implementation types and device alerts, e.g., alert events. For example, a service test may be run after a change is implemented with respect to remediating an alert event, and results of the service test may be used to assess the success of the task at remediating the alert event. An understanding of the historical impact of change implementation types and device alerts enables risks associated with change implementation to be utilized, as for example by decision makers such as network operations teams including network engineers, to substantially prioritize, triage, manage, and/or react to device events, alerts, incidents, etc. that are identified as actionable. The ability to consider the probability of historical service impact of change implementation allows network operations team to effectively obtain dynamic suggestions relating to which events or incidents within a network infrastructure are likely to be actionable, and enables tuning of policies relating to event or incident response. As a result, tasks may be prioritized for execution, e.g., by a network operations team, and determinations may be made as to when tasks may be implemented based on a service-oriented approach to event management and incident handling.

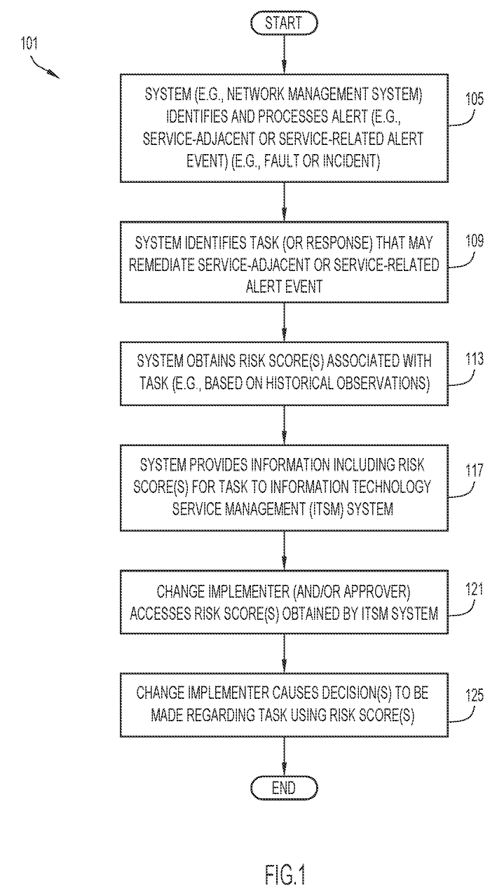

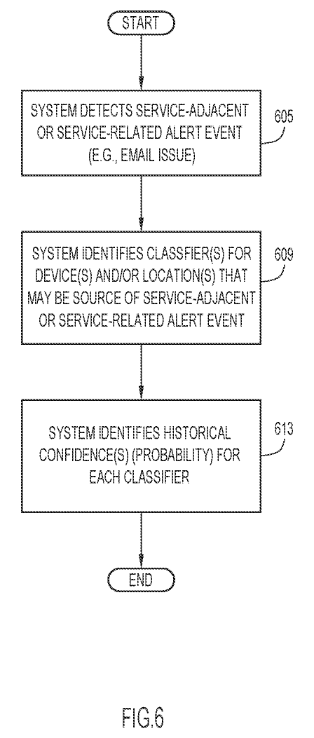

FIG. 1 is a process flow diagram which illustrates a method of implementing a change in a network by considering a historical confidence score in accordance with an embodiment. A method 101 of implementing a change in a network begins at a step 105 in which a system, e.g., a network management system (NMS), identifies and processes an alert event or alarm event. Typically, the alert event is a service-adjacent or service-related alert event, although it should be appreciated that the alert event is not limited to being a service-adjacent or service-related alert event. The system may include a detect function that is configured to detect service-adjacent or service-related alert events or alarm events, e.g., a device may report a service-adjacent or service-related alert event to the system. The service-adjacent or service-related alert event may effectively be identified on a particular device within a network. The service-adjacent or service-related alert event may either be an actionable service-adjacent or service-related alert event or a non-actionable service-adjacent or service-related alert event. Service-adjacent or service-related alert events or may represent identifiable degraded conditions of a device that may negatively impact or degrade a service that runs on the device or a service that is supported by the device. Such degraded conditions may have effects on services including, but not limited to including, email transmission. One embodiment of identifying and processing a service-adjacent or service-related alert event associated with email transmission will be discussed below with reference to FIG. 6.

In a step 109, the system identifies a task or a response that may remediate or otherwise address the service-adjacent or service-related alert event. The task is arranged to implement a change that is expected to remediate the service-adjacent or service-related alert event. The task may remediate or address the service-adjacent or service-related alert event by clearing, obviating, repairing, or otherwise overcoming the service-adjacent or service-related alert event. The system may identify the task utilizing a match or recommendation function to match or to map the service-adjacent or service-related alert event to the task. Classifiers such as those assigned by a system administrator of the network may be used to match the service-adjacent or service-related alert event to the task.

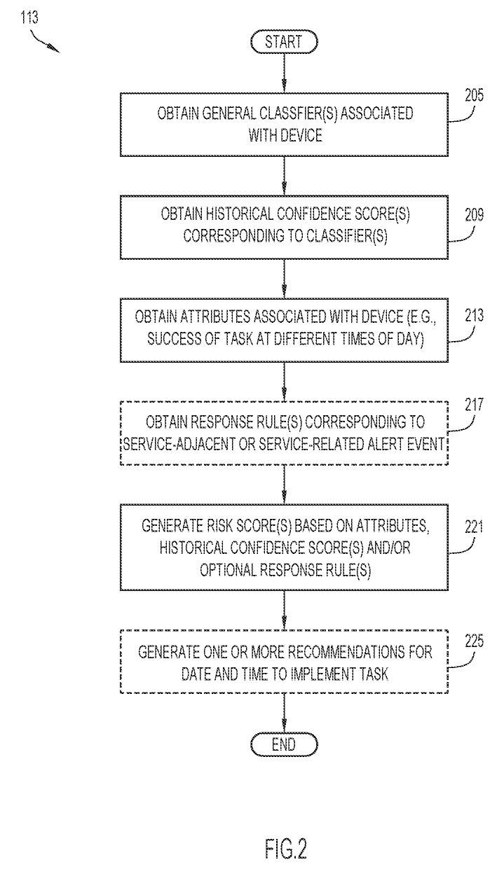

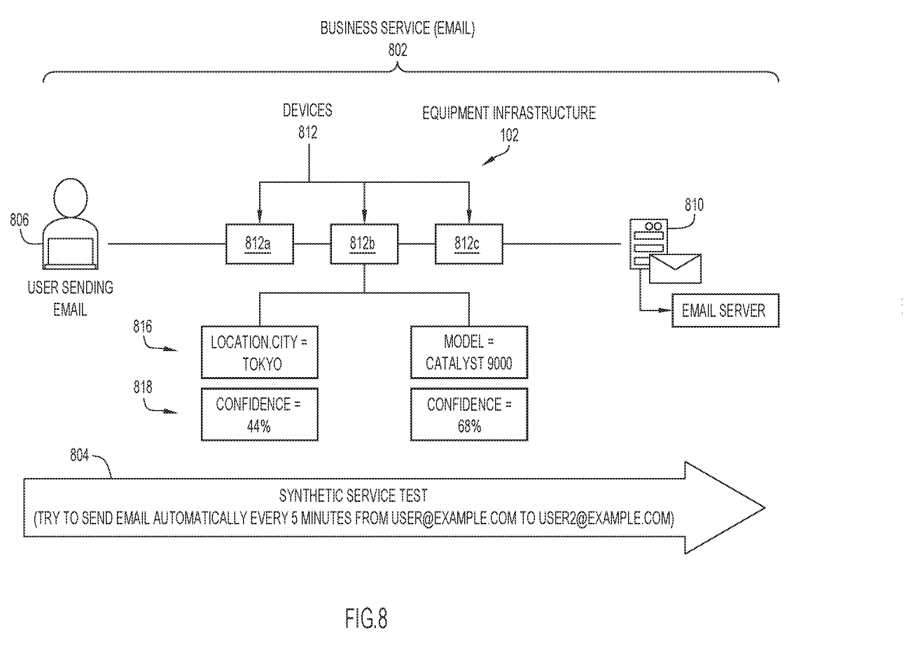

Once the system identifies a task, the system obtains one or more risk scores associated with the task in a step 113. That is, the system assesses the risks of performing the task in response to the service-adjacent or service-related alert event. The one or more risk scores may be based on historical observations of a service impact from service test results. One method of obtaining one or more risk scores will be described below with respect to FIG. 2. Service tests will be discussed below with respect to FIG. 8.

After the system obtains one or more risk scores associated with the task, the system provides information to an information technology service management (ITSM) system in a step 117. The information that is provided may identify the task, and may generally include the one or more risk scores. By providing the information to the ITSM system, the information may be accessed to enable a decision to be made as to whether to implement the task and/or when to implement the task.

From step 117, process flow proceeds to a step 121 in which a change implementer and/or a change approver accesses one or more risk scores from the ITSM system. More generally, the change implementer accesses information from the ITSM system that relates to the service-adjacent or service-related alert event. It should be appreciated that the change implementer may be a network engineer that is part of a network operations team, although the change implementer is not limited to being part of a network operations team. In one embodiment, the one or more risk scores are provided to the change implementer during a time of planning and infrastructure change management.

The change implementer causes one or more decisions to be made regarding the task using one or more risk scores in a step 125. In other words, the change implementer ascertains whether a task is to be performed and, if so, when the task is to be performed. One method of causing one or more decisions to be made regarding the task will be discussed below with reference to FIG. 2. Upon a decision being made regarding the task, the method of implementing a change in a network is completed.

FIG. 2 is a process flow diagram which illustrates a method of obtaining one or more risk scores for a task, e.g., step 113 of FIG. 1, in accordance with an embodiment. Method or step 113 of obtaining one or more risk scores for a task begins at a step 205 in which one or more general classifiers associated with the device that triggered an alert event or alarm are obtained. Classifiers generally include descriptive labels or tags that identify commonality among devices to which the classifiers are assigned. That is, the classifiers may be assigned to groups of devices to identify device commonality that is distinct for each group. Classifiers may include and/or define logical attributes of devices. For example, classifiers may include, but are not limited to including, device locations, device types, device models, business identities, etc. A classifier may define a set of classifier values or sub-classifiers. By way of example, a classifier for a device location may identify a city such as San Jose and Tokyo, while a classifier for a business identity may be “Enterprise A” or “Enterprise B.” Classifiers, classifier values, and sub-classifiers may all generally be referred to as “classifiers.”

Once one or more general classifiers associated with the device are obtained, one or more historical confidence scores that correspond to the one or more classifiers are obtained in a step 209. Historical confidence scores, or confidences, are typically mapped to corresponding ones of classifiers such that there is one historical confidence score per classifier. Historical confidence scores may represent computed, calculated, and/or observed historical probabilities that correspond to tasks performed to remediate a particular service-adjacent or service-related alert event.

In a step 213, attributes associated with the device are obtained. The attributes may provide, for example, an indication of the success of a task implemented or otherwise performed on the device at different times of a day. In one embodiment, the attributes are logical attributes included in, or defined by, classifiers.

After attributes associated with the device are obtained, process flow proceeds to an optional step 217 in which one or more response rules corresponding to the service-adjacent or service-related alert event are obtained. Response rules may compare historical confidence scores against confidence thresholds to determine whether a task is permitted or denied. It should be appreciated that in some situations, a human may make recommendations.

In a step 221, one or more risk scores associated with the task are generated based at least on the attributes, the one or more historical confidence scores, and/or one or more optional response rules. From step 221, process flow may proceed to an optional step 225 in which one or more recommendations for a date and time to implement the task in order to remediate the service-adjacent or service-related alert event are generated, and the method of obtaining one or more risk scores is completed.

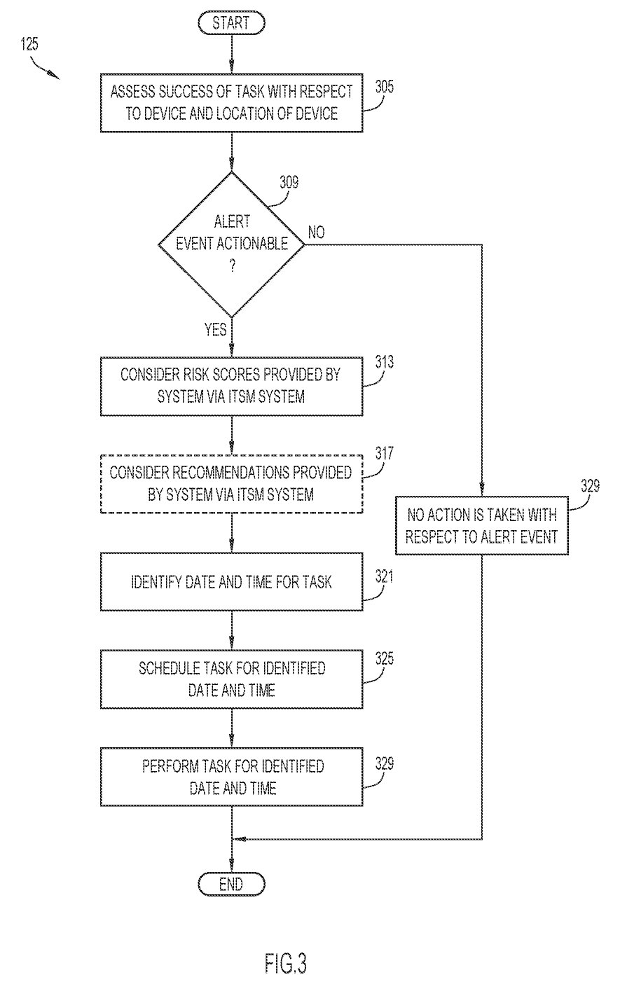

Referring next to FIG. 3, a method of a change implementer causing one or more decisions to be made regarding a task, e.g., step 125 of FIG. 1, will be described in accordance with an embodiment. Method or step 125 of a change implementer causing one or more decisions to be made regarding a task begins at a step 305 in which the change implementer assesses the potential success of the task with respect to the device and the location of the device.

Once the change implementer assesses the success of the task, a determination is made as to whether the service-adjacent or service-related alert event is actionable in a step 309. That is, it is determined whether the task is to be implemented in an effort to remediate the service-adjacent or service-related alert event, or whether the service-adjacent or service-related alert event is to be allowed to be effectively unaddressed. Historical information collected using service tests may be used to assess a likelihood that the service-adjacent or service-related alert event is actionable.

To determine whether a service-adjacent or service-related alert event is actionable, an information technology infrastructure library (ITIL) framework may be used to effectively guide how device events may be classified and treated. Device events may include, but are not limited to including, alerts, logs, key performance indicators, metrics, etc. Device events may be treated as informational, warnings, or exceptions. For example, an exception may generally be identified as an actionable service-adjacent or service-related alert event, and information or a warning may generally be identified as a non-actionable service-adjacent or service-related alert event. An event that is classified as an exception may be associated with an investigation and/or remediating task to be performed, e.g., by an engineer or by an automated process. An event that is classified as information or a warning may be logged for historical purposes and/or analytics.

Confidence scores based on the classification of a device may also be used to inform a determination of whether a service-adjacent or service-related alert event is actionable. For example, confidence scores may have values which indicate that a particular issue on a first type of device at a first location causes a service impact a relatively high percentage of time, whereas the same issue on a same type of device at a second location causes a service impact a relatively low percentage of time.

If the determination in step 309 is that the service-adjacent or service-related alert event is actionable, then in a step 313, the change implementer considers the risk scores provided by the system via or through the ITSM system. The change implementer may also consider optional recommendations provided by the system via the ITSM system in an optional step 317.

In a step 321, using risks scores and optional recommendations, the change implementer may identify a date and a time to complete the task. That is, a date and a time at which a task is to be scheduled to be run or executed are identified. The date and time may generally be selected to substantially minimize disruption to a network infrastructure and/or an ability to provide service, although it should be appreciated that a date and time may be selected based on a variety of different criteria.

Once a date and a time are identified, the task is scheduled in a step 325 for the identified date and time. The task is performed at the identified data and time in a step 329. The task may be performed by an engineer, or the task may be automated. Once the task is performed, the method of a change implementer causing one or more decisions to be made regarding a task is completed.

Returning to step 309 and the determination of whether the service-adjacent or service-related alert event is actionable, if the determination is that the service-adjacent or service-related alert event is not actionable, then process flow proceeds to a step 329 in which no action is taken with respect to the service-adjacent or service-related alert event. The method of a change implementer causing one or more decisions to be made regarding a task is completed once no action is taken with respect to the service-adjacent or service-related alert event.

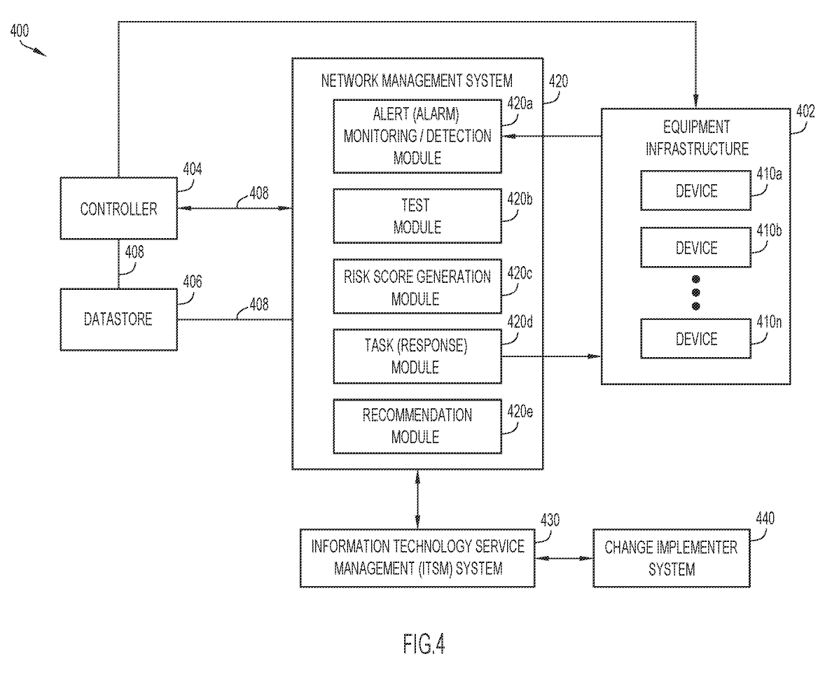

With reference to FIG. 4, an overall system which enables a historical confidence score to be considered when determining whether to cause a task to be performed will be described in accordance with an embodiment. An overall system 400 includes an equipment infrastructure 402, which may be configured as a network that supports various network-based services. Overall system 400 also includes a controller 404 accessible by an administrator, a datastore 406, and a network 408 connected to equipment infrastructure 402 to substantially enable equipment infrastructure 402, controller 404, and datastore 406 to communicate with each other. An NMS 420, an ITSM system 430, and a change implementer system 440 are also included in overall system 400.

Controller 404 may implement, or be in communication with, a complex rules engine (not shown) to define and evaluate logic for response rules that essentially create flexibility to substantially ensure that an administrator may control a desired level of match to any given situation for any possible response action. It should be appreciated that although controller 404 is illustrated as a single entity, controller 404 may instead include multiple network management and control entities. Controller 404 may discover devices 410a-n using any known or hereafter developed device discovery technique. In one embodiment, controller 404 may store, or cause to be stored, classifiers assigned to groups of the devices to identify device commonality that is distinct for each group.

Network 408 may include one or more wide area networks (WANs) and one or more local area networks (LANs), that convey traffic such as data packets between equipment infrastructure 402, controller 404, and datastore 406 using any known or hereafter developed communication protocols, such as the transmission control protocol (TCP), Internet Protocol (IP), and the like.

Equipment infrastructure 402 includes a collection of interconnected equipment or devices 410a-n, such as equipment provided in a data center, network, etc. Devices 410a-n may include, but are not limited to including, hardware devices, applications hosted on the hardware devices, and/or virtual devices, and may generally provide compute, storage, and network resources in a data center and/or network 408. Equipment infrastructure 402 may include servers, network devices such as routers and switches, and the like. By way of example, device 410a may be a server, device 410b may be a router, and device 410n may be a switch. Devices 410a-n may be co-located at a geographic location or “geolocation,” or may be distributed across multiple spaced-apart geolocations. Devices 410a may generally communicate with controller 404 over network 408. In addition, equipment infrastructure 402 may effectively form part of network 408.

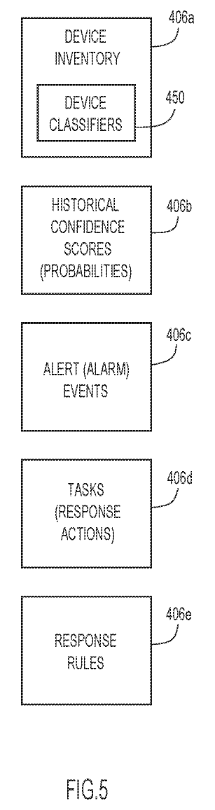

Controller 404 has access to datastore 406, which may be stored locally to the controller or offsite. Datastore 406 will be discussed below with respect to FIG. 5. Controller 404 also communicates with NMS 420.

NMS 420, which may be a network event manager, is substantially separate from controller 404 and configured to communicate with or interact with controller 404, datastore 406, and equipment infrastructure 402 to provide a change implementer with information that enables the change implementer to cause a task to be run to remediate a service-adjacent or service-related alert event. In general, NMS 420 provides information to ITSM system 430, and a change implementer or decision maker may access ITSM system 430 using change implementer system 440. ITSM system 430 may generally be an ITSM tool or a device controller. ITSM system 430 may present a risk score and/or a recommendation regarding a task to change implementer system 440 such that a change implementer may access the risk score and/or the recommendation. Change implementer system 440 may be, but is not limited to being, a computing device that may be accessed by a change implementor. It should be appreciated that change implementer system 440 may obtain information from, and provide information to, ITSM system 430.

NMS 420 includes an alert or alarm monitoring/detection module 420a, a test module 420b, a risk score generation module 420c, a task or response module 420d, and a recommendation module 420e. Alert monitoring/detection module 420a is configured to detect service-adjacent or service-related alert events on devices 410a-n. It should be appreciated that alert monitoring/detection module 420a is not limited to being included in NMS 420, and may generally be located substantially anywhere within system 400. Test module 420b is configured to run a test, as for example a synthetic service test, within overall system 400 to enable a historical confidence score to be updated after a task is executed to remediate a service-adjacent or service-related alert event. Risk score generation module 420c is configured to generate one or more risk scores associated with a task based on classifiers and historical confidence scores. Task module 420d is configured to identify a task or a response that may remediate a service-adjacent or service-related alert event detected by alert monitoring/detection module 420a. Task module 420d is also configured to cause a task to execute on device 410a-n which triggered a service-adjacent or service-related alert event when a change implementer indicates that the task is to be executed. That is, task module 420d may apply a response to an appropriate device 410a-n upon receiving an indication from ITSM system 430. Recommendation module 420e may provide a recommendation, as for example a recommendation of when to execute a task, to a change implementer through ITSM system 430 and change implementer system 440.

NMS 420 also registers the service-adjacent or service-related alert events with controller 404 to enable controller 404 to perform functions not provided by NMS 420. As such, NMS 420 effectively reduces a computation burden on controller 404.

FIG. 5 is a diagrammatic representation of datastore 406 in accordance with an embodiment. Datastore 406 includes a device inventory 406a that identifies devices 410a-n of FIG. 4 as well as device classifiers 450. Datastore 406 also includes historical confidence scores 406b associated with corresponding ones of device classifiers 450, a list of alert events 406c, a list of and executable components of tasks 406d mapped to corresponding ones of alert events 406c, and response rules 406e mapped to corresponding ones of tasks 406d. Device inventory 406a includes an inventory of devices 410a-n of FIG. 4 as discovered by controller 404. Controller 404 may discover devices 410a-n using any known or hereafter developed device discovery technique. Device inventory 406a includes identifiers of, and other information related to, devices 410a-n of FIG. 4 including, but not limited to including, IP addresses, device names, etc. Data objects described herein may be mapped to each other using any known or hereafter developed mapping constructs such as address pointers, shared data object names, common memory spaces, database mapping constructs, etc.

Device classifiers are assigned to devices 410a-n of FIG. 4 as listed in device inventory 406a. In one embodiment, an administrator may assign device classifiers 450 to devices 410a-n of FIG.4 during provisioning of overall system 400 and thereafter. In another embodiment, device classifiers 450 may be arranged on devices 410a-n of FIG. 4, and may be discoverable by controller 404. Device classifiers 450 include descriptive labels or tags that identify commonality among devices 410a-n of FIG. 4 to which device classifiers 450 are assigned. Device classifiers 450 may include or otherwise define logical attributes of devices 410a-n of FIG. 4.

In general, the steps associated with a system such as an NMS effectively detecting a service-adjacent or service-related alert event or alarm event may vary. Typically, the steps include identifying classifiers , locations, and historical confidences. FIG. 6 is a process flow diagram which provides an example method of identifying and processing a service-adjacent or service-related alert event, e.g., step 105 of FIG. 1, in accordance with an embodiment. Method or step 105 of identifying and processing a service-adjacent or service-related alert event begins at a step 605 in which a system such as an NMS detects a service-adjacent or service-related alert event. By way of example, the system may detect or otherwise identify an issue with a business service such as an email issue that may result in the business service being identified as substantially unhealthy.

Once the service-adjacent or service-related alert event is detected, the system identifies one or more classifiers and/or locations for one or more devices in a step 609 which may be the source of the service-adjacent or service-related alert event. By way of example, classifiers and/or locations of devices in an equipment infrastructure that may be in a path between an email server of a business service and a receiving node. The one or more classifiers for a device may include a device type and a location. The device type may be, but is not limited to being, a switch and/or a router. The location may specify a city at which a device is located. For example, the classifiers for a particular device associated with an email service may specify that the device type is a router, that the particular device is a specific model such as “Catalyst 9000,” and that the location is “Tokyo.”

From step 609, process flow moves to a step 613 in which the system identifies one or more historical confidence scores for each classifier. For example, the historical confidence scores for a device type, a device model, and a location may be specified as a percentage of confidence. After the one or more historical confidence scores are identified, the method of identifying and processing a service-adjacent or service-related alert event is completed.

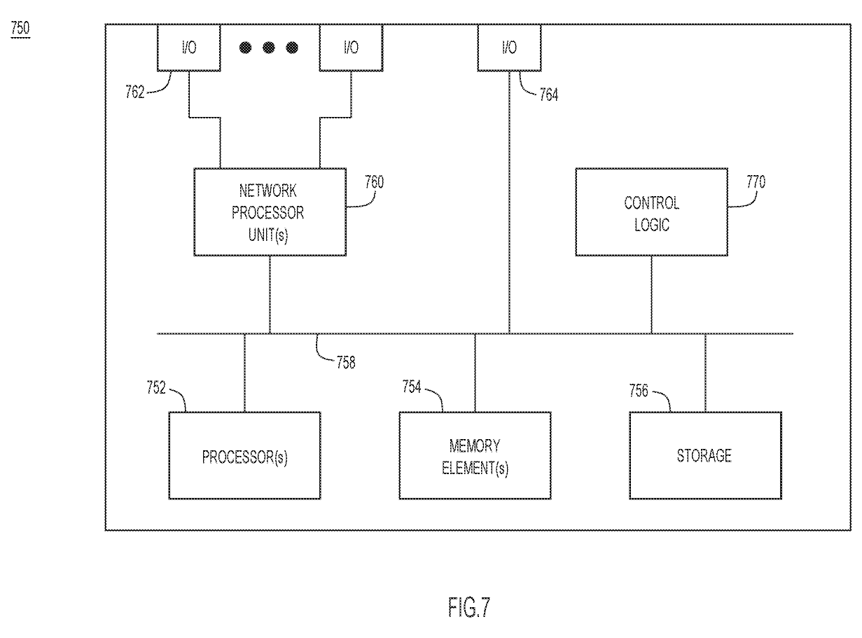

Referring next to FIG. 7, a computing system or device which is suitable for performing functions associated with operations discussed with respect to FIGS. 1-6 will be described in accordance with an embodiment. In some embodiments, an apparatus or computing device 750 may be configured as any entity or entities as discussed for the techniques depicted in connection with FIGS. 1-6 in order to perform operations of the various techniques discussed herein. For example, computing device 750 may represent controller 404 and devices 410a-n of FIG. 4.

Computing device 750 may be any apparatus that may include one or more processor(s) 752, one or more memory element(s) 754, storage 756, a bus 758, one or more network processor unit(s) 760 interconnected with one or more network input/output (I/O) interface(s) 762, one or more input/output (I/O) interface(s) 764, and control logic 770. In some embodiments, instructions associated with logic for computing device 750 may overlap in any suitable manner, and are not limited to the specific allocation of instructions and/or operations described herein.

Processor(s) 752 may include at least one hardware processor configured to execute various tasks, operations, and/or functions for computing device 750 as described herein according to logic, software, and/or instructions configured for computing device 750. Processor(s) 752, as for example one or more hardware processors, may execute substantially any type of instructions associated with data to achieve the operations detailed herein. By way of example, processor(s) 752 may transform an element or an article such as data or information from one state or thing to another state or thing. Any of potential processing elements, microprocessors, digital signal processor, baseband signal processor, modem, PHY, controllers, systems, managers, logic, and/or machines described herein may be construed as being encompassed within the broad term “processor.”

Memory element(s) 754 and/or storage 756 may be configured to store data, information, software, and/or instructions associated with computing device 750, and/or logic configured for memory element(s) 754 and/or storage 756. By way of example, any logic described herein such as control logic 770 may, in some embodiments, be stored for computing device 750 using any combination of memory element(s) 754 and/or storage 756. It should be appreciated that storage 756 may be consolidated with memory element(s) 754, or vice versa, and/or may overlap or exist in any other suitable manner.

In one embodiment, bus 758 may be configured as an interface that enables one or more elements of computing device 750 to communicate in order to exchange information and/or data. Bus 758 may be implemented with substantially any architecture designed for passing control, data and/or information between processors, memory elements or storage, peripheral devices, and/or any other hardware and/or software components that may be configured for computing device 750. In at least one embodiment, bus758 may be implemented as a fast kernel-hosted interconnect, potentially using shared memory between processes, as for example logic, which may enable efficient communication paths between the processes.

Network processor unit(s) 760 may enable communication between computing device 750 and other systems, entities, etc., via network I/O interface(s) 762 which may be wired and/or wireless to facilitate operations discussed for various embodiments described herein. Network processor unit(s) 760 may be configured as a combination of hardware and/or software, such as one or more Ethernet driver(s) and/or controller(s) or interface cards, optical driver(s) and/or controller(s) such as Fibre Channel, wireless receivers/transmitters/transceivers, baseband processor(s)/modem(s), and/or other similar network interface driver(s) and/or controller(s) now known or hereafter developed to enable communications between computing device 750 and other systems, entities, etc. to facilitate operations for various embodiments described herein. In one embodiment, network I/O interface(s) 762 may be configured as one or more Ethernet port(s), Fibre Channel ports, any other I/O port(s), and/or antenna(s)/antenna array(s) now known or hereafter developed. Thus, network processor unit(s) 760 and/or network I/O interface(s) 762 may include suitable interfaces for receiving, transmitting, and/or otherwise communicating data and/or information in a network environment.

I/O interface(s) 764 may allow for input and output of data and/or information with other entities that may be connected to computing device 750. For example, I/O interface(s) 764 may provide a connection to external devices such as a keyboard, keypad, a touch screen, and/or any other suitable input and/or output device now known or hereafter developed. In some instances, external devices may also include, but are not limited to including, portable computer readable, non-transitory storage media such as database systems, thumb drives, portable optical or magnetic disks, and memory cards. External devices may also include a structure or mechanism arranged to display data to a user, such as, for example, a computer monitor, a display screen, or the like.

Control logic 770 may include instructions that, when executed, cause processor(s) 752 to perform operations, which may include, but are not limited to including, providing overall control operations of computing device; interacting with other entities, systems, etc. described herein; maintaining and/or interacting with stored data, information, parameters, etc. as for example memory element(s), storage, data structures, databases, tables, etc.; combinations thereof; and/or the like to facilitate various operations for embodiments described herein.

The programs described herein, as for example control logic 770 may be identified based upon one or more applications for which the programs are implemented in a specific embodiment. However, it should be appreciated that any particular program nomenclature herein is used merely for convenience; thus, embodiments herein should not be limited to use(s) solely described in any specific application(s) identified and/or implied by such nomenclature.

With reference to FIG. 8, service tests will be discussed in accordance with an embodiment. FIG. 8 shows an example service 802 supported by an equipment infrastructure 102 and a service test 804 (labeled “synthetic test” in FIG. 8) employed to test the health of the service such as a business service. Service 802 includes an email service to send email from a user 806 to an email server 810 over devices 812 of equipment infrastructure 102. Devices 812 include a device 812a (e.g., a switch), a device 812b (e.g., a router), and a device 812c (e.g., a switch). As shown, a datastore includes classifiers 816 (location.city = Tokyo, model = Catalyst 9000) assigned to device 812b and historical confidence scores 818 (44%, 68%) corresponding to the classifiers.

“Over-the-top” service test 804 periodically (e.g., every 5 minutes) attempts to send a test email originated at user2@example.com through devices 812, to produce periodic test results. The test results build historical confidence scores (e.g., historical confidence scores 818) within classifiers (e.g., classifiers 816) to which multiple devices may belong.

Although only a few embodiments have been described in this disclosure, it should be understood that the disclosure may be embodied in many other specific forms without departing from the spirit or the scope of the present disclosure. By way of example, after a task is executed in an effort to remediate a service-adjacent or service-related alert event, it may be determined whether the remediation was successful. In one embodiment, in order to update historical confidences after a task is executed to remediate a service-adjacent or service-related alert event associated with a device, a service test may be performed, e.g., using test module 420b of FIG. 4, to test a service supported by the device, and the results from the service test may be monitored and the results may be used to update the historical confidences. If the results indicate that the task successfully remediated the service-adjacent or service-related alert event, then historical confidence scores may be increased, whereas if the results indicate that the task did not successfully remediate the service-adjacent or service-related alert event, then historical confidences scores may be decreased.

Historical confidence scores may be computed within multiple localized/specific classifiers of groups of devices or “scopes.” Scopes may include, but are not limited to including, devices within the same city, devices that are the same model, devices that match a specific business, etc. Scopes may also include a global scope that spans the localized/specific classifiers, as for example across substantially all cities, across substantially all models, and across substantially all businesses.

Historical confidence scores or historical probabilities of success of particular tasks or responses may be reinforced based on historical success rates of the tasks or responses compared within specific classifiers. By way of example, success rates of the responses performed on devices specifically in a location such as Tokyo, or specifically for a device such as a Catalyst® 9004 device by Cisco Systems, Inc., may be utilized. The embodiments may also provide automatic closed-loop measurements of success using “synthetic” service tests, and using a human reinforcement layer of observation and influence. In one embodiment, historical confidence scores may be reinforced based on historical success rates of tasks or responses. For instance, results of a synthetic service test performed after a task is executed to remediate a service-adjacent or service-related alert event may be used to update a historical confidence score associated with utilizing the task to remediate the service-adjacent or service-related alert event.

A relatively complex rules engine may allow for relatively granular control over response rules to permit responses to run, i.e., execute, or not run with specificity for the specific classifiers associated with a given device. An administrator may control an amount of risk that may be tolerated with specificity for a given device, its location, or other parameters, as not all devices in all environments tolerate the same level of risk. The embodiments further permit role-based human reinforcement of the historical confidence scores.

In some aspects, the techniques described herein relate to a method including: associating, to classifiers assigned to a plurality of groups of devices of a network to identify device commonality that is distinct for each group of the plurality of groups, historical confidence scores with which a task remediates an alert event; when a first device of the devices reports the alert event, identifying each classifier to which the first device belongs and each historical confidence score for each classifier; generating at least one risk score associated with the task using at least the each historical confidence score based on a result of a service test; providing the at least one risk score to a system; and obtaining an indication of whether the task is to be executed on the first device from the system.

In some aspects, the techniques described herein relate to a method further including: obtaining at least one attribute associated with the first device, and wherein generating the at least one risk score includes using the at least one attribute to generate the at least one risk score.

In some aspects, the techniques described herein relate to a method further including: generating a recommendation, the recommendation including a time at which to execute the task; and providing the recommendation to the system, wherein the system is one selected from a group including an information technology service management (ITSM) system and a change implementer system.

In some aspects, the techniques described herein relate to a method wherein the recommendation is provided to the ITSM system, and the indication is based on an assessment of the at least one risk score provided to the ITSM system and the recommendation, the assessment being performed using a change implementer system.

In some aspects, the techniques described herein relate to a method wherein the classifiers include descriptive labels that define commonality between the devices.

In some aspects, the techniques described herein relate to a method wherein the alert event is a service-adjacent or service-related alert event when the indication indicates that the task is to be executed, the method further includes: determining when the task is executed; when it is determined that the task is executed, performing the service test to test a service supported across the devices; monitoring test results from the service test; and after the service test, updating each confidence score using the test results.

In some aspects, the techniques described herein relate to a method wherein obtaining the indication of whether the task is to be executed on the first device from the system includes: determining when the task has been executed, wherein providing the at least one risk score to the system includes providing the at least one risk score to the change implementer during a time of planning and infrastructure change management.

In some aspects, the techniques described herein relate to an apparatus including: one or more network processor units to communicate with devices in a network; and a processor coupled to the one or more network processor units and configured to perform: associating, to classifiers assigned to a plurality of groups of devices of a network to identify device commonality that is distinct for each group of the plurality of groups, historical confidence scores with which a task remediates an alert event, when a first device of the devices reports the alert event, identifying each classifier to which the first device belongs and each historical confidence score for each classifier, generating at least one risk score associated with the task using at least the each historical confidence score based on a result of a service test, providing the at least one risk score to a system, and obtaining an indication of whether the task is to be executed on the first device from the system.

In some aspects, the techniques described herein relate to an apparatus wherein the processor is further configured to perform: obtaining at least one attribute associated with the first device, and wherein generating the at least one risk score includes using the at least one attribute to generate the at least one risk score.

In some aspects, the techniques described herein relate to an apparatus wherein the processor is further configured to perform: generating a recommendation, the recommendation including a time at which to execute the task; and providing the recommendation to the system, wherein the system is one selected from a group including an information technology service management (ITSM) system and a change implementer system.

In some aspects, the techniques described herein relate to an apparatus wherein when the recommendation is provided to the ITSM system, the indication is based on an assessment of the at least one risk score provided to the ITSM system and the recommendation, the assessment being performed using a change implementer system.

In some aspects, the techniques described herein relate to an apparatus wherein the classifiers include descriptive labels that define commonality between the devices.

In some aspects, the techniques described herein relate to an apparatus wherein when the indication indicates that the task is to be executed and the alert event is a service-adjacent or service-related alert event, the processor is further configured to perform: determining when the task is executed; when it is determined that the task is executed, performing the service test to test a service supported across the devices; monitoring test results from the service test; and after the service test, updating each confidence score using the test results.

In some aspects, the techniques described herein relate to an apparatus wherein the processor is configured to perform obtaining the indication of whether the task is to be executed on the first device from the ITSM system by: determining when the task has been executed, wherein providing the at least one risk score to the system includes providing the at least one risk score to the change implementer during a time of planning and infrastructure change management.

In some aspects, the techniques described herein relate to a non-transitory computer readable medium encoded with instructions that, when executed by a processor configured to communicate with devices over a network, causes the processor to perform: associating, to classifiers assigned to a plurality of groups of devices of a network to identify device commonality that is distinct for each group of the plurality of groups, historical confidence scores with which a task remediates an alert event; when a first device of the devices reports the alert event, identifying each classifier to which the first device belongs and each historical confidence score for each classifier; generating at least one risk score associated with the task using at least the each historical confidence score based on a result of a service test; providing the at least one risk score to a system; and obtaining an indication of whether the task is to be executed on the first device from the system.

In some aspects, the techniques described herein relate to a non-transitory computer readable medium wherein the instructions further cause the processor to perform: obtaining at least one attribute associated with the first device, and wherein generating the at least one risk score includes using the at least one attribute to generate the at least one risk score.

In some aspects, the techniques described herein relate to a non-transitory computer readable medium wherein the instructions further cause the processor to perform: generating a recommendation, the recommendation including a time at which to execute the task; and providing the recommendation to the system, wherein the system is one selected from a group including an information technology service management (ITSM) system and a change implementer system.

In some aspects, the techniques described herein relate to a non-transitory computer readable medium wherein the indication is based on an assessment of the at least one risk score provided to the ITSM system and the recommendation, the assessment being performed using a change implementer system.

In some aspects, the techniques described herein relate to a non-transitory computer readable medium wherein the classifiers include descriptive labels that define commonality between the devices.

In some aspects, the techniques described herein relate to a non-transitory computer readable medium wherein when the indication indicates that the task is to be executed and the alert event is a service-adjacent or service-related alert event, the instructions further cause the processor to perform: determining when the task is executed; when it is determined that the task is executed, performing the service test to test a service supported across the devices; monitoring test results from the service test; and after the service test, updating each confidence score using the test results.

In various embodiments, any entity or apparatus as described herein may store data/information in any suitable volatile and/or non-volatile memory item such as a magnetic hard disk drive, solid state hard drive, semiconductor storage device, random access memory (RAM), read only memory (ROM), erasable programmable read only memory (EPROM), application specific integrated circuit (ASIC), etc., software, logic, hardware, and/or in any other suitable component, device, element, and/or object as may be appropriate. Logic may include, but is not limited to including, fixed logic, hardware logic, programmable logic, analog logic, and/or digital logic. Any of the memory items discussed herein may be construed as being encompassed within the broad term “memory element.” Data or information being tracked and/or sent to one or more entities as discussed herein may be provided in any suitable database, table, register, list, cache, storage, and/or storage structure, all of which may be referenced at any suitable timeframe. Any such storage options may also be included within the broad term “memory element” as used herein.

It should be understood that in certain example implementations, operations as set forth herein may be implemented by logic encoded in one or more tangible media that is capable of storing instructions and/or digital information and may be inclusive of non-transitory tangible media and/or non-transitory computer readable storage media. The logic may include, but is not limited to including, embedded logic provided in an ASIC, digital signal processing (DSP) instructions, software that potentially includes of object code and source code, etc. for execution by one or more processors, and/or other similar machines, etc. Generally, memory element(s) 754 and/or storage 756 may store data, software, code, instructions such as processor instructions, logic, parameters, combinations thereof, and/or the like used for operations described herein. Memory element(s) 754 and/or storage 756 may be able to store data, software, code, instructions such as processor instructions, logic, parameters, combinations thereof, or the like that are executed to carry out operations in accordance with teachings of the present disclosure.

In some instances, software of the present embodiments may be available via a non-transitory computer useable medium of a stationary or portable program product apparatus, downloadable file(s), file wrapper(s), object(s), package(s), container(s), and/or the like. A non-transitory computer useable medium may include, but is not limited to including, magnetic or optical mediums, magneto-optic mediums, CD-ROM, DVD, memory devices, etc. In some instances, non-transitory computer readable storage media may also be removable. For example, a removable hard drive may be used for memory or storage in some implementations. Other examples may include, but are not limited to including, optical and magnetic disks, thumb drives, flash drives, and smart cards that may be inserted into and/or otherwise connected to a computing device for transfer onto another computer readable storage medium.

Embodiments described herein may include one or more networks, which can represent a series of points and/or network elements of interconnected communication paths for receiving and/or transmitting messages such as packets of information that propagate through the one or more networks. These network elements offer communicative interfaces that facilitate communications between the network elements. A network can include any number of hardware and/or software elements coupled to, and in communication with, each other through a communication medium. Such networks may include, but are not limited to including, substantially any local area network (LAN), virtual LAN (VLAN), wide area network (WAN) such as the Internet, software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications, e.g., 4G/5G/nG. Other suitable technologies for communications include IEEE 802.11, IEEE 802.16, and/or wired communications. IEEE 802.11 communications include, but are not limited to including, Wi-Fi® and Wi-Fi6®. IEEE 802.16 communications include, but are not limited to including, Worldwide Interoperability for Microwave Access (WiMAX), Radio-Frequency Identification (RFID), Near Field Communication (NFC), Bluetooth™, mm.wave, and Ultra-Wideband (UWB), etc.). Wired communications include, but are not limited to including, T1 lines, T3 lines, digital subscriber lines (DSL), Ethernet, and Fibre Channel, etc. Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. that allow for the exchange of data and/or information. The algorithms, communication protocols, interfaces, etc. may be proprietary and/or non-proprietary.

In various example implementations, any entity or apparatus for various embodiments described herein may encompass network elements that may include virtualized network elements, functions, etc.)= such as, for example, network appliances, forwarders, routers, servers, switches, gateways, bridges, load balancers, firewalls, processors, modules, radio receivers and/or transmitters, and/or any other suitable device, component, element, or object operable to exchange information that facilitates or otherwise helps to facilitate various operations in a network environment as described for various embodiments herein. The examples provided should not limit the scope or inhibit the broad teachings of systems, networks, etc. described herein as potentially applied to a myriad of other architectures.

Communications in a network environment can be referred to herein as “messages,” “messaging,” “signaling,” “data,” “content,” “objects,” “requests,” “queries,” “responses,” “replies,” etc. which may be inclusive of packets. As referred to herein and in the claims, the term “packet” may be used in a generic sense to include packets, frames, segments, datagrams, and/or any other generic units that may be used to transmit communications in a network environment. Generally, a packet is a formatted unit of data that can contain control or routing information and data, which is also sometimes referred to as a “payload,” “data payload,” and variations thereof. Control or routing information may include, but is not limited to including, a source and destination address, a source and destination port, etc.) In some embodiments, control or routing information, management information, and/or the like may be included in packet fields, such as within header(s) and/or trailer(s) of packets. Internet Protocol (IP) addresses may include any IP version 4 (IPv4) and/or IP version 6 (IPv6) addresses.

To the extent that embodiments presented herein relate to the storage of data, the embodiments may employ any number of any conventional or other databases, data stores or storage structures such as files, databases, data structures, data, or other repositories, etc. to store information.

It should be appreciated that references to various features including, but not limited to including, elements, structures, nodes, modules, arrangements, configurations, components, engines, logic, steps, operations, functions, characteristics, etc., included in “one embodiment,” “example embodiment,” “an embodiment,” “another embodiment,” “certain embodiments,” “some embodiments,” “various embodiments,” “other embodiments,” “alternative embodiment,” “such embodiments,” and/or the like are intended to mean that any such features are included in one or more embodiments of the present disclosure, but may or may not necessarily be combined in the same embodiments. It should also be understood that a module, engine, client, controller, function, logic and/or the like may be inclusive of an executable file comprising instructions that may be understood and processed on a server, computer, processor, machine, compute node, combinations thereof, and/or the like and may further include library modules loaded during execution, object files, system files, hardware logic, software logic, an/or any other executable modules.

The operations and steps described with reference to the preceding figures, as for example process flow diagrams, illustrate substantially only some of the possible scenarios that may be executed by one or more entities discussed herein. Some of these operations may be deleted or removed where appropriate, and/or steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase “at least one of,” “one or more of,” “and/or,” “variations thereof,” and/or the like are open-ended expressions that are both conjunctive and disjunctive in operation for any and all possible combinations of the associated listed items. For example, each of the expressions “at least one of X, Y and Z,” “at least one of X, Y or Z,” “one or more of X, Y and Z,” “one or more of X, Y or Z,” and “X, Y and/or Z” may mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms “first,” “second,” “third,” etc., are intended to distinguish the particular nouns they modify, as for example, element, condition, node, module, arrangement, activity, operation, etc. Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, and/or hierarchy of the two elements. Further, as referred to herein, “at least one of” and “one or more of” may be represented using the “(s)” nomenclature, as for example when referring to “one or more element(s).”

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
associating, to classifiers assigned to a plurality of groups of devices of a network to identify device commonality that is distinct for each group of the plurality of groups, historical confidence scores with which a task remediates an alert event;
when a first device of the devices reports the alert event, identifying each classifier to which the first device belongs and each historical confidence score for each classifier;
generating at least one risk score associated with the task using at least the each historical confidence score based on a result of a service test;
providing the at least one risk score to a system; and
obtaining an indication of whether the task is to be executed on the first device from the system.

2. The method of claim 1, further including:
obtaining at least one attribute associated with the first device, and wherein generating the at least one risk score includes using the at least one attribute to generate the at least one risk score.

3. The method of claim 1, further including:
generating a recommendation, the recommendation including a time at which to execute the task; and
providing the recommendation to the system, wherein the system is one selected from a group including an information technology service management (ITSM) system and a change implementer system.

4. The method of claim 3, wherein the recommendation is provided to the ITSM system, and the indication is based on an assessment of the at least one risk score provided to the ITSM system and the recommendation, the assessment being performed using a change implementer system.

5. The method of claim 1, wherein the classifiers include descriptive labels that define commonality between the devices.

6. The method of claim 1, wherein the alert event is a service-adjacent or service-related alert event when the indication indicates that the task is to be executed, the method further includes:
determining when the task is executed;
when it is determined that the task is executed, performing the service test to test a service supported across the devices;
monitoring test results from the service test; and
after the service test, updating each confidence score using the test results.

7. The method of claim 1, wherein obtaining the indication of whether the task is to be executed on the first device from the system includes:
determining when the task has been executed, wherein providing the at least one risk score to the system includes providing the at least one risk score to a change implementer during a time of planning and infrastructure change management.

8. An apparatus comprising:
one or more network processor units to communicate with devices in a network; and
a processor coupled to the one or more network processor units and configured to perform:
associating, to classifiers assigned to a plurality of groups of devices of a network to identify device commonality that is distinct for each group of the plurality of groups, historical confidence scores with which a task remediates an alert event,
when a first device of the devices reports the alert event, identifying each classifier to which the first device belongs and each historical confidence score for each classifier,
generating at least one risk score associated with the task using at least the each historical confidence score based on a result of a service test,
providing the at least one risk score to a system, and
obtaining an indication of whether the task is to be executed on the first device from the system.

9. The apparatus of claim 8, wherein the processor is further configured to perform:
obtaining at least one attribute associated with the first device, and wherein generating the at least one risk score includes using the at least one attribute to generate the at least one risk score.

10. The apparatus of claim 8, wherein the processor is further configured to perform:
generating a recommendation, the recommendation including a time at which to execute the task; and
providing the recommendation to the system, wherein the system is one selected from a group including an information technology service management (ITSM) system and a change implementer system.

11. The apparatus of claim 10, wherein when the recommendation is provided to the ITSM system, the indication is based on an assessment of the at least one risk score provided to the ITSM system and the recommendation, the assessment being performed using a change implementer system.

12. The apparatus of claim 8, wherein the classifiers include descriptive labels that define commonality between the devices.

13. The apparatus of claim 8, wherein when the indication indicates that the task is to be executed and the alert event is a service-adjacent or service-related alert event, the processor is further configured to perform:
determining when the task is executed;
when it is determined that the task is executed, performing the service test to test a service supported across the devices;
monitoring test results from the service test; and
after the service test, updating each confidence score using the test results.

14. The apparatus of claim 8, wherein the processor is configured to perform obtaining the indication of whether the task is to be executed on the first device from the system by:
determining when the task has been executed, wherein providing the at least one risk score to the system includes providing the at least one risk score to a change implementer during a time of planning and infrastructure change management.

15. A non-transitory computer readable medium encoded with instructions that, when executed by a processor configured to communicate with devices over a network, causes the processor to perform:
associating, to classifiers assigned to a plurality of groups of devices of a network to identify device commonality that is distinct for each group of the plurality of groups, historical confidence scores with which a task remediates an alert event;
when a first device of the devices reports the alert event, identifying each classifier to which the first device belongs and each historical confidence score for each classifier;
generating at least one risk score associated with the task using at least the each historical confidence score based on a result of a service test;
providing the at least one risk score to a system; and
obtaining an indication of whether the task is to be executed on the first device from the system.

16. The non-transitory computer readable medium of claim 15, wherein the instructions further cause the processor to perform:
obtaining at least one attribute associated with the first device, and wherein generating the at least one risk score includes using the at least one attribute to generate the at least one risk score.

17. The non-transitory computer readable medium of claim 15, wherein the instructions further cause the processor to perform:
generating a recommendation, the recommendation including a time at which to execute the task; and
providing the recommendation to the system, wherein the system is one selected from a group including an information technology service management (ITSM) system and a change implementer system.

18. The non-transitory computer readable medium of claim 17 wherein the indication is based on an assessment of the at least one risk score provided to the ITSM system and the recommendation, the assessment being performed using a change implementer system.

19. The non-transitory computer readable medium of claim 15, wherein the classifiers include descriptive labels that define commonality between the devices.

20. The non-transitory computer readable medium of claim 15, wherein when the indication indicates that the task is to be executed and the alert event is a service-adjacent or service-related alert event, the instructions further cause the processor to perform:
determining when the task is executed;
when it is determined that the task is executed, performing the service test to test a service supported across the devices;
monitoring test results from the service test; and
after the service test, updating each confidence score using the test results.
